(19) United States
(12) Patent Application Publication
(10) Pub. No.: US 2011/0072984 A1
(43) Pub. Date: Mar. 31, 2011

(54) AUTOMATIC BEAN CURD MAKER

(76) Inventors: CHENG-FENG CHEN, Taichung Hsien (TW); JUI-TAI CHENG, Taichung Hsien (TW)

(21) Appl. No.: 12/569,900

(22) Filed: Sep. 30, 2009

(51) Int. Cl. A23C 20/02; A23L 1/20; A47J 43/04

(52) U.S. Cl. 99/483; 99/510; 99/536

(57) ABSTRACT

An automatic bean curd maker includes a computer control device, grinding device, stirring device, and molding device. The stirring device is arranged to a side of the grinding device. The molding device is arranged in front of the grinding device. The computer control device is arranged to a side of the molding device. The operation of the automatic bean curd maker assembled by above components is described in the following. The soy beans of certain proportion set by the computer control device are grinded by the grinding device as a bean pulp. The steamed bean pulp is stirred in the stirring device with coagulator as a semi-finished bean curd. The semi-finished bean curd is coagulated by removing moisture and gas in the molding device as a finished bean curd.

### FIELD OF THE INVENTION

The present invention relates to bean curd maker, and particular to an automatic bean curd maker capable of automatically producing standardized bean products such as bean milk, soy bean curd, and dried bean curd by automatic control of computer.

### DESCRIPTION OF THE PRIOR ART

Bean curds in conventional market, supermarket, or hypermarket are all fixed and mass-produced. The technique of conventional bean curd is going to disappear by its complicated and long processes. The adding of gypsum and water of the process controlled by an operator is such a waste time and man power so that people are not willing to step into especially in the modern industrial generation. The disadvantages of the prior art is that the inventor want to solve.

### SUMMARY OF THE PRESENT INVENTION

Accordingly, the primary object of the present invention is to provide an automatic bean curd maker capable of automatically producing standardized bean products such as bean milk, soy bean curd, and dried bean curd by automatic control of computer.

A secondary object of the present invention is to provide better quality and efficiency for bean curd manufacturing.

To achieve above object, the present invention provides an automatic bean curd maker having computer control device, grinding device, stirring device, and molding device comprising: the computer control device having recipes for producing bean products with proportions of soy bean, coagulator, and water; the grinding device including a bean supplier, grinder, steamer, and centrifugal filter; the stirring device including a positioning sensor, cylinder, pneumatic valve, quantified bean milk pump, quantified coagulator pump, stirring tank, retaining plate, stirring, rotary platform, and pipeline; the molding device including a pushing rod, coagulating plate, molding plate, raising cylinder, and pressing plate; by the above components, the automatic bean curd maker being capable of automatically producing standardized products such as bean milk, soy bean curd, and dried bean curd by automatic control of computer.

### BRIEF DESCRIPTION OF THE DRAWINGS

FIG. 1 is a schematic view showing an assembly of an automatic bean curd maker of the present invention.

FIG. 2 is a schematic view showing a computer control device of the automatic bean curd maker of the present invention.

FIG. 3 is a schematic view showing an assembly of a grinding device of the automatic bean curd maker of the present invention.

FIG. 3-1 is an assembly view of a steamer of the automatic bean curd maker of the present invention.

FIG. 4 is a schematic view showing an assembly of a stirring device of the automatic bean curd maker of the present invention.

FIG. 5 is a schematic view showing an assembly of a molding device of the automatic bean curd maker of the present invention.

FIG. 6 is an assembly view of a stirring tank of the automatic bean curd maker of the present invention.

FIG. 7 is a schematic view showing a molding operation of the automatic bean curd maker of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

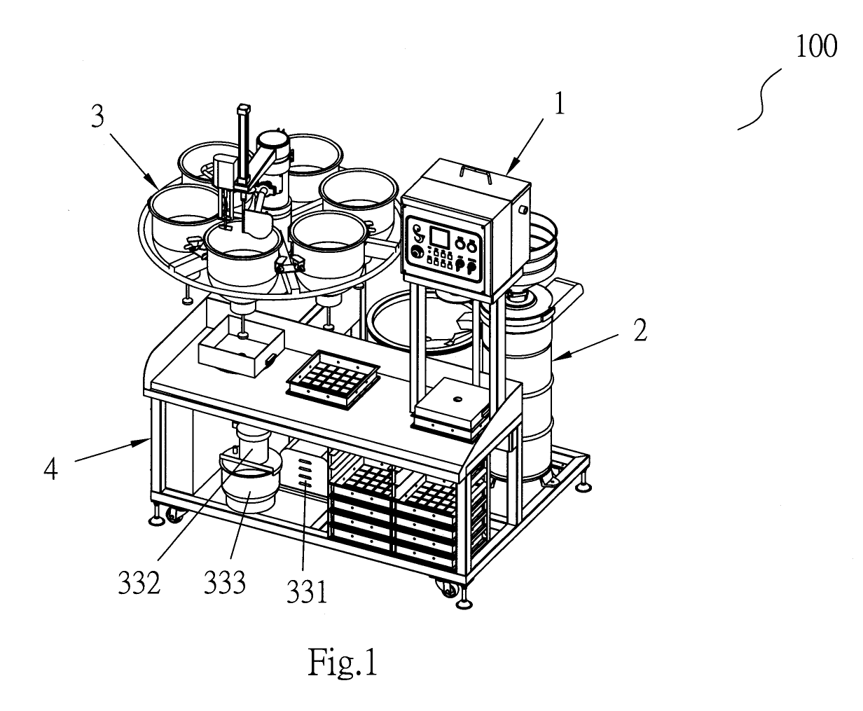

Referring to FIG. 1, an assembly drawing of an automatic bean curd maker according to the present invention is shown. The automatic bean curd maker 100 is assembled by a computer control device 1, grinding device 2, stirring device 3, and molding device 4. The stirring device 3 is arranged to a side of the grinding device 2. The molding device 4 is arranged in front of the grinding device 2. The computer control device 1 is arranged to a side of the molding device 4. The operation of the automatic bean curd maker composed by above components is described in the following. The soy beans of certain proportion set by the computer control device 1 are grinded by the grinding device 2 as bean pulp. The steamed bean pulp is stirred in the stirring device 3 with coagulator as a semi-finished bean curd. The semi-finished bean curd is coagulated by removing moisture and gas in the molding device 4 as a finished bean curd.

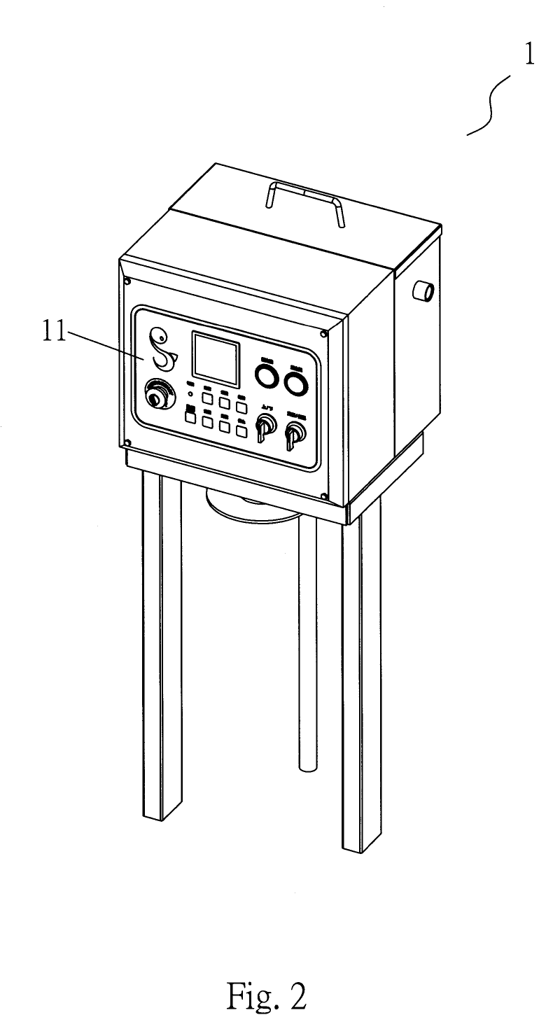

Referring to FIG. 2, a schematic view showing the computer control device 1 of the automatic bean curd maker is illustrated. A control panel 11 is arranged to the computer control device 1 so that user can manipulate and confirm the operations.

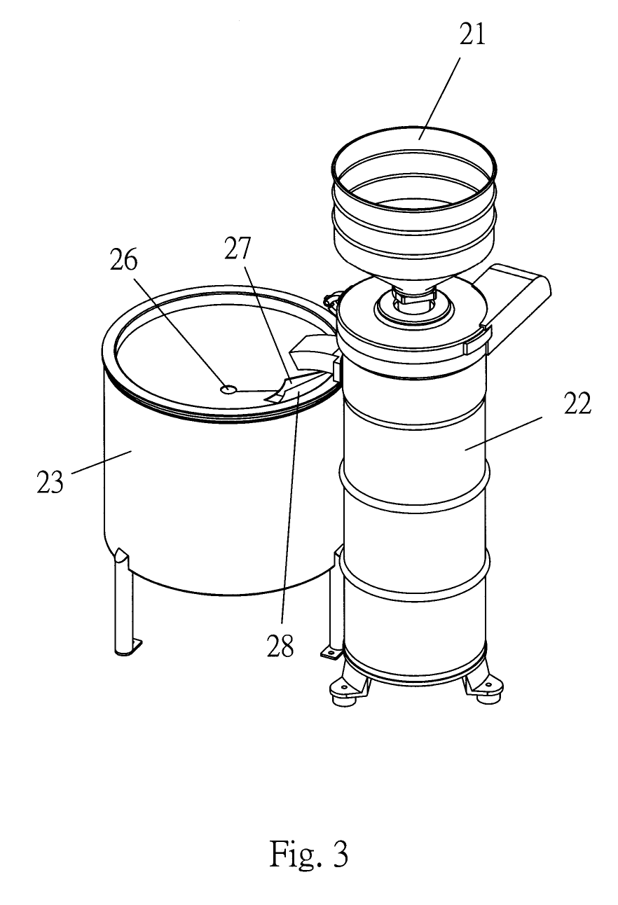

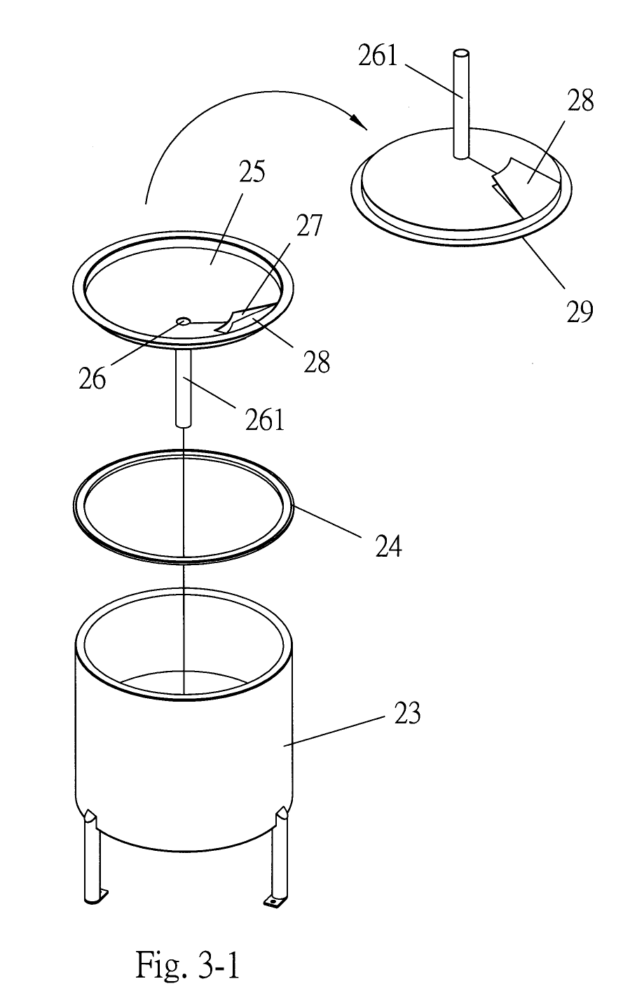

Referring to FIGS. 3 and 3-1, schematic views showing the assemblies of the grinding device and a steamer are illustrated. The grinding device 2 is assembled by a bean supplier 21, grinder 22, and steamer 23. The soy beans are added to the bean supplier 21. Proportioned soy beans will be supplied to the grinder 22 by the computer control device 1. The soy beans will be meshed by the grinder 22 as soy pulp. Dregs of the bean pulp will be filtered by a centrifugal filter arranged to the grinder 22. The filtered bean pulp will be steamed by the steamer 23 with additional water. The steamer 23 includes a cover body 29, a sealing rubber 24 is arranged between the cover body 29 and the steamer 23. A top surface of the cover body is concave as a cone sink 25, the sink 25 has a backflow hole 26 and a open hole 27. The open hole has a plate 28, and there is a drop height between the open hole 27 and the plate 28 so as to prevent splash of the bean pulp. The backflow hole 26 locates in the lowest bottom of the sink 25, and a pipe 261 is extended from the backflow hole 26 towards the steamer 23. The bubbles overflowed from the open hole 27 will be liquefied and flow back to the steamer 23 from the backflow hole 26 so as to prevent bubbles and also to ensure a safety and save a cost.

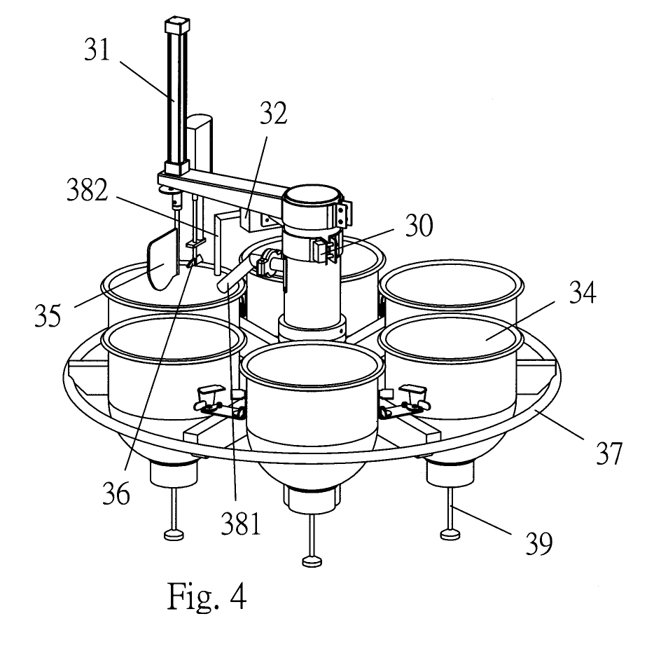

Referring to FIGS. 1 and 4, schematic views showing an assembly and operation of the stirring device 3 are illustrated. The stirring device 3 is assembled by a positioning sensor 30, cylinder 31, pneumatic valve 32, quantified bean pulp pump 331, quantified coagulator pump 332, stirring tank 34, retaining plate 35, stirring 36, rotary platform 37, bean pulp pipeline 381, coagulator pipeline 382, coagulator storage tank 333, and pushing rod 39. The steamed bean pulp is supplied to the stirring tank 34 by the bean pulp pipeline 381. The stirring tank 34 is rotated by the rotary platform 37 and positioned by the positioning sensor 30. The coagulator with a predetermined proportion is supplied to the stirring tank 34 from the coagulator storage tank 333 through the coagulator pipeline 382. The retaining plate 35 and the stirring 36 are deployed by the cylinder 31 so as to stir. The quantified coagulator pump 332 and the coagulator pipeline 382 will remain cycling to prevent the coagulator from solidifying. The pneumatic valve 32 is capable of controlling the flow of the coagulator. The bean pulp will be uniformly stirred by the irregular flow caused by the blocking of the retaining plate 35 while the stirring 36 is working. When the stirring 36 is stopped, the flowing bean pulp will stay steady by the blocking of the retaining plate 35. At least one stirring tank 34 is arranged to the maker. Each stirring tank 34 is stirred for one and half minutes by the control of the computer control device 1 and the stirring process will be completed within about 9 minutes. Each stirring tank 34 is stirred with a predetermined interval by the rotary platform 37 so as to prevent the bean milk from solidifying. The stirred bean milk will be supplied to a coagulating plate 41 through the pushing rod 39.

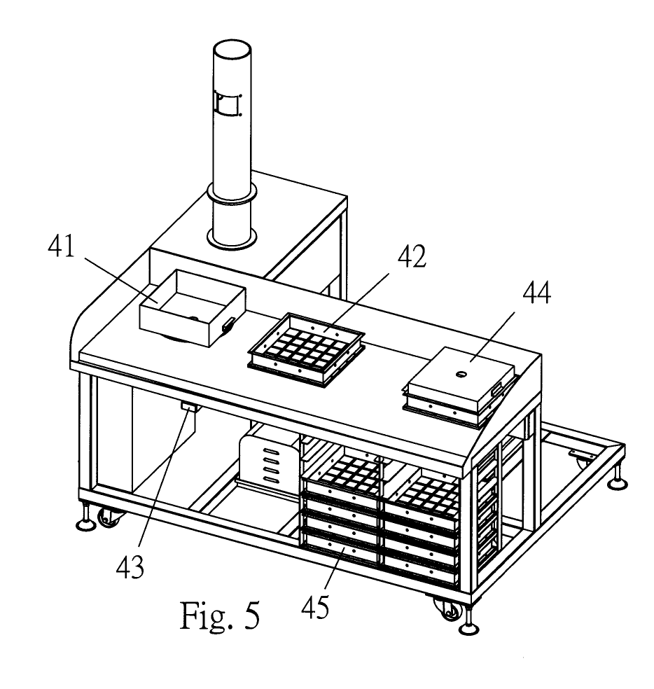

Referring to FIG. 5, an assembly view showing the molding device of the present invention is illustrated. The molding device 4 includes the coagulating plate 41, molding plate 42, raising cylinder 43, pressing plate 44 and waiting area 45. The various stirred bean products will be poured downwards by the raising cylinder 43 pushing the pushing rod 39 and then will coagulate in the coagulating plate 41 and will be molded in the molding plate 42. After being pressed by the pressing plate 44 to remove the moisture and gas, the pressed material will be stored in the waiting area for further formation so that the whole process is completed.

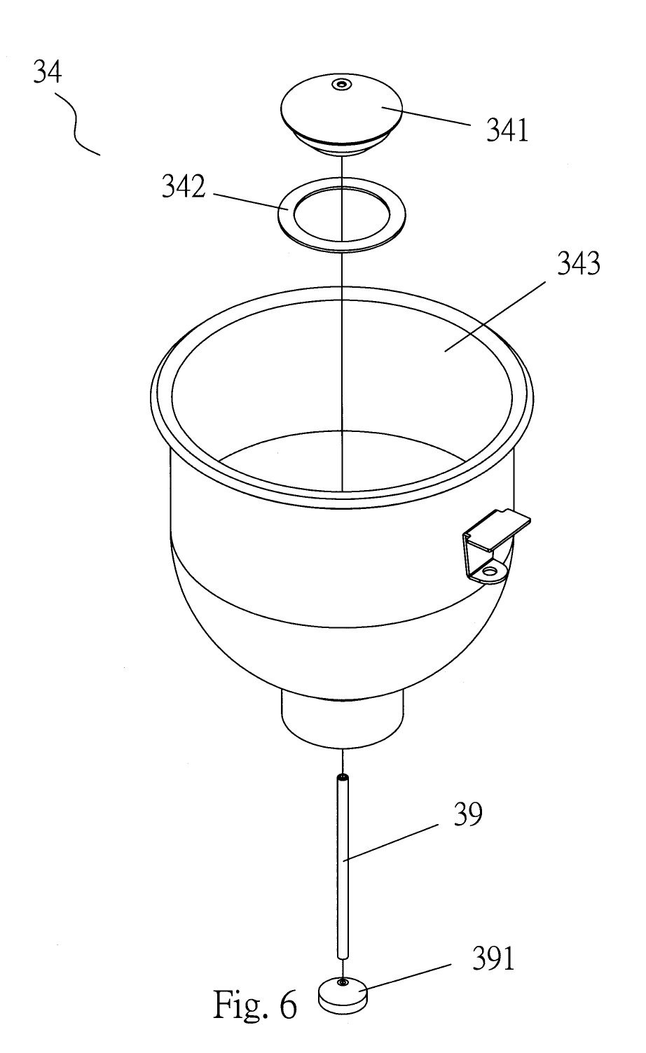

The assembly of the stirring tank of the present invention is illustrated in FIG. 6. The stirring tank 34 is a tank 343 having a gasket 342 fixed by a gasket retaining seat 341, and a bottom side thereof includes the pushing rod 39 and a pushing rod retaining seat 391.

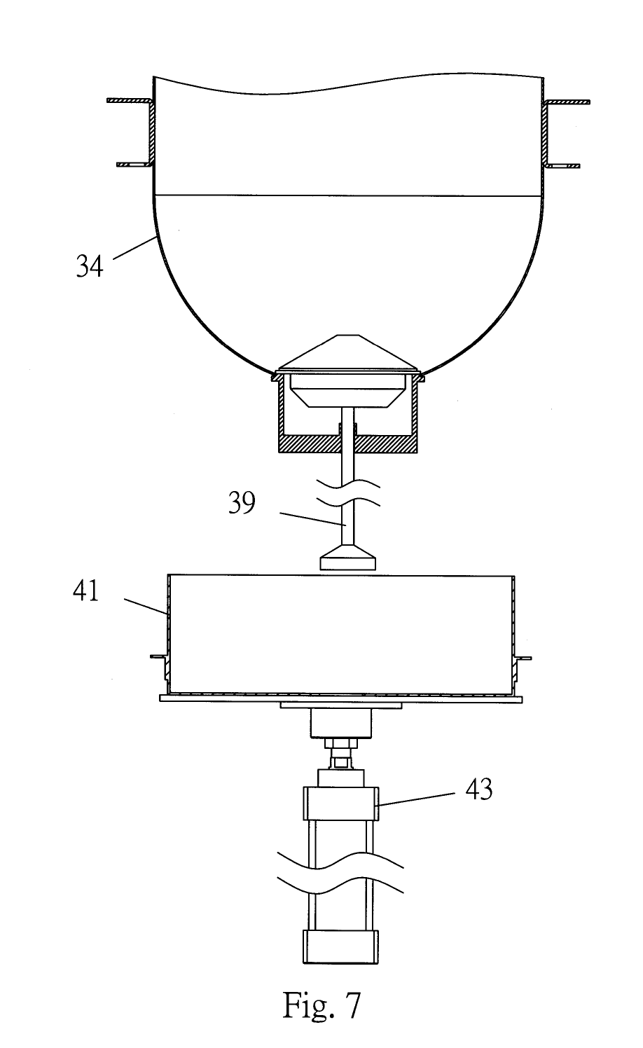

The molding operation of the present invention is illustrated in FIG. 7. The bean pulp in the stirring tank 34 will flow into the coagulating plate 41 through the pushing rod 39 by the raising cylinder 43 pressing the pushing rod 39.

Advantages of the present invention are list in the following:

1. The proportions of the various bean products are controlled by the computer control device so that the products are automatically produced and standardized.

2. Process time and man power are saved by the automatic control of the computer control device.

3. The automatic beam curd maker is controlled by computer so that people are willing to learn and the technique of beam curd is lasted.

4. The automatic beam curd maker is controlled by computer so that the tool can be continuously operated and there is no problem of underproduction.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automatic bean curd maker having computer control device, grinding device, stirring device, and molding device comprising:
the computer control device having recipes for producing bean products with proportions of soy bean, coagulator, and water;
the grinding device including a bean supplier, grinder, steamer, and centrifugal filter;
the stirring device including a positioning sensor, cylinder, pneumatic valve, quantified bean milk pump, quantified coagulator pump, stirring tank, retaining plate, stirring, rotary platform, and pipeline;
the molding device including a pushing rod, coagulating plate, molding plate, raising cylinder, and pressing plate;
by the above components, the automatic bean curd maker being capable of automatically producing standardized products such as bean milk, soy bean curd, and dried bean curd by automatic control of computer.

2. The automatic bean curd maker as claimed in claim 1, wherein the proportioned soy beans will be supplied to the grinder by the computer control device; the soy beans will be meshed with water by the grinder as a soy pulp, dregs of the bean pulp will be filtered by the centrifugal filter; the filtered bean pulp will be steamed by the steamer with additional water.

3. The automatic bean curd maker as claimed in claim 1, wherein a steamed bean pulp is supplied to the stirring tank of the stirring device by the quantified bean milk pump; the stirring tank is positioned by the positioning sensor, and coagulator with predetermined volume is supplied to the stirring tank through the coagulator pipeline; the retaining plate will block the flow of the beam pulp, and the beam pulp is stirred by the stirring motivated by the cylinder so that the bean pulp is not solidified; at least one stirring tank is arranged and each stirring tank is stirred with a predetermined interval by the rotary platform so that all the stirring tank is uniformly stirred.

4. The automatic bean curd maker as claimed in claim 1, wherein various stirred bean products will be poured downwards by the raising cylinder pushing the pushing rod and then will coagulate in the coagulating plate and will be molded in the molding plate; after being pressed by the pressing plate to remove the moisture and gas, the pressed material will be stored in a waiting area for further formation so that a bean curd is completed.

5. The automatic bean curd maker as claimed in claim 1, wherein a gasket is arranged in the stirring device; the gasket is pushed up so that beam milk will flow into the coagulating plate.

6. The automatic bean curd maker as claimed in claim 1, wherein the quantified coagulator pump is capable of supplying different volume of coagulator to produce different kind of bean product.

7. The automatic bean curd maker as claimed in claim 1, wherein the stirring device has a motor in a bottom side; the motor will rotate a magnet inside the stirring tank by magnetic induction so as to prevent bean milk inside the stirring tank from sediment.

8. The automatic bean curd maker as claimed in claim 1, wherein the steamer includes a cover body, a sealing rubber is arranged between the cover body and the steamer; a top surface of the cover body is concave as a cone sink, the sink has a backflow hole and a open hole; the open hole has a plate, and there is a drop height between the open hole and the plate so as to prevent splash of the bean pulp; the bubbles overflowed from the open hole will be liquefied and flow back to the steamer from the backflow hole.
